(19) United States
(12) Patent Application Publication
(10) Pub. No.: US 2011/0050963 A1
(43) Pub. Date: Mar. 3, 2011

(54) IMAGE CAPTURING APPARATUS AND IMAGE ENCODING APPARATUS

(75) Inventor: Akihiro WATABE, Nara (JP)

(73) Assignee: Panasonic Corporation, Osaka (JP)

(21) Appl. No.: 12/943,373

(22) Filed: Nov. 10, 2010

Related U.S. Application Data
(63) Continuation of application No. PCT/JP2009/001289, filed on Mar. 24, 2009.

(30) Foreign Application Priority Data
May 19, 2008 (JP) 2008-131066

(51) Int. Cl. H04N 5/262

(52) U.S. Cl. 348/240.2; 348/E05.055

(57) ABSTRACT

On an operation monitor, a portion of an image captured by a wide-angle optical system which is to be zoomed in is selected, and an image in the area is captured by a telephoto optical system. Then, both of the images are multiplexed in a signal processor, and the multiplexed images are recorded on a recording medium.

### CROSS-REFERENCE TO RELATED APPLICATION

This is a continuation of PCT International Application PCT/JP2009/001289 filed on Mar. 24, 2009, which claims priority to Japanese Patent Application No. 2008-131066 filed on May 19, 2008. The disclosures of these applications including the specifications, the drawings, and the claims are hereby incorporated by reference in their entirety.

### BACKGROUND

The present invention relates to an image capturing apparatus, and more particularly relates to an image capturing apparatus optimally suitable for use in a camcorder capable of capturing images using a zoom.

Conventionally, many types of camcorders have optical zooms, assuming that users use such camcorders at school athletic meets, etc., thereby allowing users to shoot their children clearly from a distance.

Although those types of camcorders are convenient to shoot telephoto images, there are also demands for shooting images showing overall scenes from various different angles, and for shooting telephoto images, especially when shooting images of group performances, etc. For example, broadcasting stations ordinarily use multiple cameras to capture images by cameras having different roles; and subsequently edit the images.

However, shooting home video is generally done by a single person, and it is unrealistic for an amateur person to use multiple cameras.

Thus, techniques enabling a single camera to record both telephoto images and wide-angle images have been proposed (see, e.g., Japanese Patent Publication No. H09-215012). Some techniques using multiple cameras set up side by side have been proposed (see, e.g., Japanese Patent Publication No. 2001-268409).

### SUMMARY

For recording telephoto images and wide-angle images, systems including that described in Japanese Patent Publication No. H09-215012 have been on the marketplace, but still leave room for improvement.

First, when shooting a performance in an athletic meet, the user's main subject (e.g., the user's child who is performing), to which you need to draw viewer's attention, is not always positioned at the center of a frame showing the entire performance scene, i.e., an entire scene to be recorded as a wide-angle image).

Although, in such a situation, entire performers are positioned within a fixed area, individual performers frequently move around. As such, overview video images need to be shot with a fixed line of sight, while a line of sight along which video is shot needs to track the main subject.

In order to achieve the similar object, a technique can be used, in which wide-angle video is recorded, and then, a part of the recorded video is enlarged during playback. However, such a technique requires the recorded video to be edited after recording. Locating the user's child in the picture area and magnifying the view is cumbersome. Although, alternatively, magnified images can be separately created, the location of the subject needs to be continuously designated during playback. Only after the video has been played back for editing, a final, desired video is obtained.

In order to maintain acceptably sufficient quality of the magnified images in this case, the original video needs to be recorded with a higher resolution and a higher quality, resulting in an increased amount of the data.

In addition, when recording two video sequences, operability during playback has to be considered. If the two video sequences are recorded as unassociated images, only one video sequence can be seen at a time.

Although it may be possible to switch between the two video sequences, such switching cannot produce visual effects unique to telephoto shooting, and can only perform simple switching between two playback images.

Thus, to address at least the above-mentioned problems, various solutions are disclosed herein.

An image capturing apparatus includes an imaging capturing device configured to capture an image; a telephoto area selector configured to select a portion of the image being captured by the image capturing device; an image encoder configured to encode the image being captured by the image capturing device; and a recorder configured to record the portion of the image selected by the telephoto area selector, and the image encoded by the image encoder in association with each other.

In the image capturing apparatus, the telephoto area selector configured to select a portion of the image being captured by the image capturing device is provided, and the portion of the image selected by the telephoto area selector, and the image encoded by the image encoding means are recorded in association with each other. Thus, further effective playback can be realized.

The image capturing apparatus further includes a monitor configured to display the image being captured by the image capturing device in real-time, wherein the portion of the image selected by the telephoto area selector is displayed on the monitor.

Thus, in the image capturing apparatus, the operability in area selection by the telephoto area selector can be increased.

In the image capturing apparatus, the portion of the image selected by the telephoto area selector is enlarged, and the enlarged image is displayed on the monitor.

Thus, in the image capturing apparatus, a user can easily perform confirmation of the selected portion of the image by the telephoto area selector.

In the image capturing apparatus, the telephoto area selector selects, as the portion of the image, a predetermined area around a location specified by a user within the image displayed on the monitor.

Thus, in the image capturing apparatus, area selection can be performed to the image displayed on the monitor using an intuitive touch operation, etc., and thus, area selection can be easily performed.

The image capturing apparatus further includes a telephoto image encoder configured to encode an enlarged image of the portion of the image selected by the telephoto area selector, wherein the recorder records the enlarged image encoded by the telephoto image encoder, and the image encoded by the image encoder in association with each other.

Thus, in the image capturing apparatus, the enlarged image in the portion of the image selected by the telephoto area selector is encoded as an independent image, and thus, the enlarged image can be independently recorded.

The image capturing apparatus further includes a multiplexer configured to multiplex the enlarged image encoded by the telephoto image encoder, and the image encoded by the image encoder into a single stream, wherein the recorder records the single stream on a recording medium.

Thus, in the image capturing apparatus, the enlarged image encoded by the telephoto image encoder, and the image encoded by the image encoder can be flexibly used as a single content.

In the image capturing apparatus, the image capturing device includes an optical system configured to capture a telephoto image in the portion of the image selected by the telephoto area selector.

In the image capturing apparatus, a plurality of optical systems are provided to achieve high image quality, and a telephoto image is obtained by an optical zoom to increase the image quality of the telephoto image.

The image capturing apparatus further includes a decimator configured to decimate the image being captured by the image capturing device to reduce a resolution of the image; and a clipper configured to clip the portion of the image selected by the telephoto area selector from the image being captured by the image capturing device, wherein the recorder records the image decimated by the decimator, and the image clipped by the clipper.

In the image capturing apparatus, when only a single optical system is provided, the image being captured by the image capturing device is decimated to reduce the amount of recorded data.

An image encoding apparatus includes a first encoder configured to receive a first video signal, area information indicating an area of the first video signal on a screen, and a second video signal, and to encode the first video signal with the area information; a second encoder configured to encode the second video signal; and a multiplexer configured to multiplex a first version encoded by the first encoder, and a second version encoded by the second encoder.

Another image encoding apparatus includes a decimator configured to decimate a first video signal to reduce a resolution; a clipper configured to clip a video signal in a selected area from the first video signal; a first encoder configured to encode the video signal decimated by the decimator, and information indicating the selected area; a second encoder configured to encode the video signal clipped by the clipper; and a multiplexer configured to multiplex a first version encoded by the first encoder, and a second version encoded by the second encoder.

Various embodiments of the invention allows more effective playback. The enlarged image in the portion of the image selected by the telephoto area selector is encoded as an independent image, and thus, the enlarged image can be independently recorded. Accordingly, a variety of playback options can be realized without requiring post editing.

The enlarged image encoded by the telephoto image encoder and the image encoded by the image encoder are multiplexed into a single stream to record the multiplexed images on a recording medium, and thus, the enlarged image encoded by the telephoto image encoder and the image encoded by the image encoder can be flexibly used as a single contents.

### BRIEF DESCRIPTION OF THE DRAWINGS

FIG. 1 is a block diagram of a camcorder according to a first embodiment.

FIG. 2 is a diagram of an example display screen of an operation monitor 109.

FIG. 3 is a diagram illustrating a general outline of a record format.

FIG. 4 is a block diagram of a signal processor 107.

FIG. 5 is a diagram of an example display screen of the operation monitor 109 during playback.

FIGS. 6A and 6B are diagrams of example display screens of the operation monitor 109 during playback.

FIG. 7 is a block diagram of a camcorder according to a second embodiment.

FIG. 8 is a block diagram of a separator 710.

### DETAILED DESCRIPTION

### First Embodiment

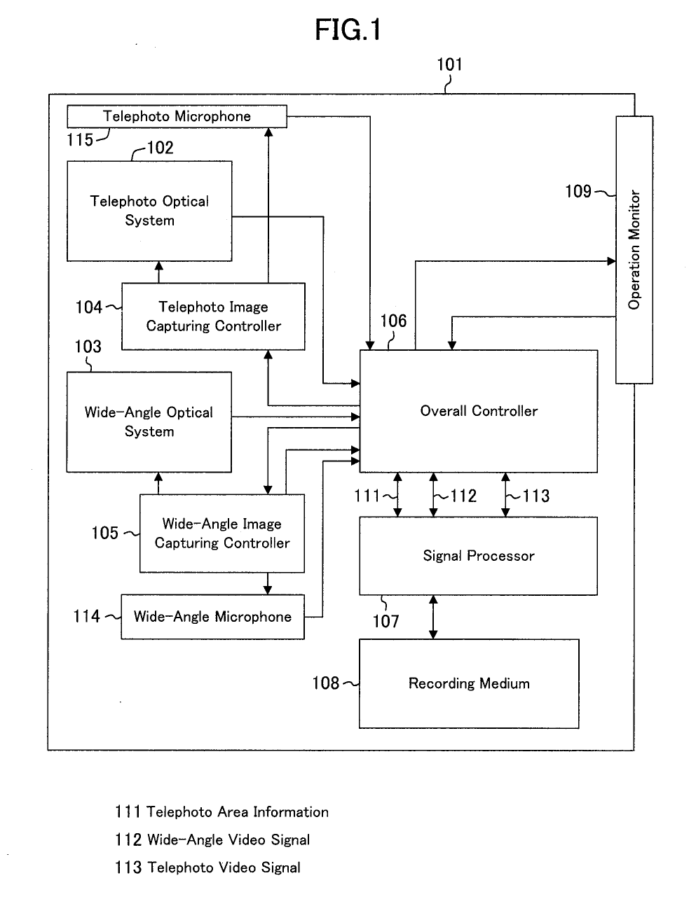

FIG. 1 is a block diagram of a camcorder (alternatively referred to as “video camera”) according to a first embodiment. A camcorder 101 of FIG. 1 includes a wide-angle optical system 103 for capturing wide-angle images, and for converting the captured images to an electrical signal. The camcorder 101 also includes a telephoto optical system 102 for capturing magnified telephoto images within an image capturing area corresponding to the wide-angle optical system 103, and for converting the captured magnified images to an electrical signal. The camcorder 101 includes a telephoto image capturing controller 104 for controlling the telephoto optical system 102, and a wide-angle image capturing controller 105 for controlling the wide-angle optical system 103. The camcorder 101 includes a wide-angle microphone 114 for converting sound to an electrical signal, and a telephoto microphone 115 for effectively converting sound in an image capturing area of the telephoto optical system 102 to an electrical signal. The camcorder 101 includes an overall controller 106 for performing an overall control, and an operation monitor 109 for monitoring various user operations and image capturing area. The camcorder 101 includes a signal processor 107 for recording images captured by the telephoto optical system 102 and the wide-angle optical system 103 with telephoto area information 111 on a recording medium 108.

Image areas captured by the telephoto optical system 102 can be moved within the captured image area of the wide-angle optical system 103. More specifically, an optical axis of the telephoto optical system 102 can be moved based on an instruction by the telephoto image capturing controller 104. Thus, changing the focal length of the telephoto optical system 102 allows a part of the image capturing area for the wide-angle optical system 103 to be magnified and captured depending on a distance from the subject.

By contrast, an optical axis of the wide-angle optical system 103 is fixed relative to a camcorder 101 body. As such, the image capturing area of the wide-angle optical system 103 is determined by a direction in which the camcorder 101 is pointing, similar to a regular camcorder.

The camcorder 101 has a feature that the optical axis of the telephoto optical system 102 can be moved. Such a feature allows a specific subject in the overall image can be captured by the telephoto optical system 102 while an overall image is captured by the wide-angle optical system 103 with the body of the camcorder 101 substantially fixed. In particular, an area on which the user wishes to zoom in does not have to be located at the center of the image capturing area of the wide-angle optical system 103. Thus, even when the subject such as a child is moving, the body of the camera 101 does not have to be moved. In other words, the overall images are continuously captured in the frame while following the moving subject.

The wide-angle microphone 114 converts sound in a relatively large area to an electrical signal, and the directivity of the wide-angle microphone 114 varies based on the focal length of the wide-angle image capturing controller 105. More specifically, when zooming in, the directivity is increased so that sound from the telephoto image area is emphasized.

Similar to the wide-angle microphone 114, the directivity of the telephoto microphone 115 varies according to a zooming operation of the telephoto optical system 102. Thus, the telephoto microphone 115 typically has a higher directivity.

The wide-angle microphone 114 and the telephoto microphone 115 are controlled in order to more effectively record overall sound and sound from the subject. For example, when all performers sing a song together, the telephoto microphone 115 picks up the user's child as a primary sound source while the wide-angle microphone 114 picks up the overall sound.

Thus, two substantially independent sets of video/audio signals are sent to the overall controller 106.

The overall controller 106 outputs these images to the operation monitor 109 to provide a feedback to the user.

The overall controller 106 also specifies the focal lengths of the wide-angle image capturing controller 105 and the telephoto image capturing controller 104 in order to manage the two image capturing areas. More specifically, during image capturing, the overall controller 106 manages a distance to the subject, the optical axis and the focal length (or the angle of view) of the telephoto optical system 102, etc. Based on such management, the overall controller 106 calculates an area within a video image being captured by the wide-angle optical system 103 which the telephoto optical system 102 is capturing, thereby managing the image capturing region. During playback, the overall controller 106 receives the telephoto area information 111 from the signal processor 107.

The overall controller 106 exchanges the telephoto area information 111, a wide-angle video signal 112 and a telephoto video signal 113 with the signal processor 107. More specifically, during image capturing, the overall controller 106 outputs information from the wide-angle optical system 103 and the wide-angle microphone 114 as the wide-angle video signal 112; and information from the telephoto optical system 102 and the telephoto microphone 115 as the telephoto video signal 113. During playback, the overall controller 106 receives such information, and displays the received information on the operation monitor 109.

The signal processor 107 performs encoding/decoding of images.

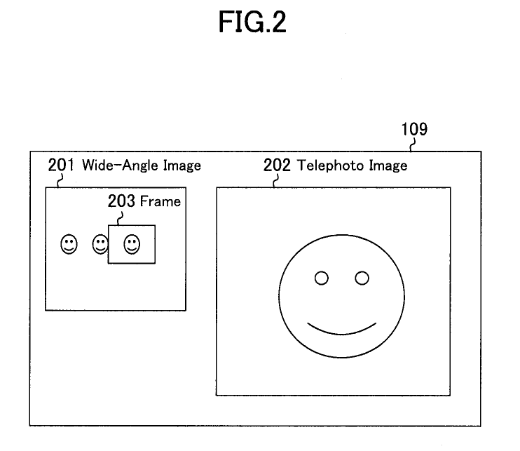

The operation during image capturing will be described in detail below. FIG. 2 shows a typical display example of the operation monitor 109 during image capturing.

As shown in FIG. 2, typically, a wide-angle image 201 and a telephoto image 202 are simultaneously displayed on the operation monitor 109, and additionally, a frame 203 is indicated in the wide-angle image 201. The frame 203 shows the image capturing area of the telephoto optical system 102. That is, to the user, an enlarged image of the frame 203 in the wide-angle image 201 is shown as the telephoto image 202.

When the captured images are displayed in the above-described manner, it is easy to follow the subject such as the user's child even while capturing an overall image. That is, since the frame 203 moves, the user can find an area for telephoto shooting very easily, and thus, the operability of the telephoto optical system 102 can be improved.

Furthermore, the operation monitor 109 of FIG. 2 is a touch panel, and is configured so that, when the user touches a predetermined area in the wide-angle image 201, the telephoto area (e.g., the frame 203) is moved to the area that the user touches. The size of the frame 203 is increased or reduced according to the focal length.

In ordinary cases, a telephoto image is more important, and thus, in general, the size of the telephoto image 202 is preferably large so that the user can easily view the image. Note that techniques which allows change in the ratio between the size of the wide-angle image 201 and the size of the telephoto image 202, or display of only one of the wide-angle image 201 and the telephoto image 202 can be utilized.

The operation monitor 109 may be configured so that the telephoto area (the location of the frame 203) can be changed not only by using a touch panel but also by using an operation lever, etc. The most important thing is to provide a feedback to the user about an area on which the optical system is zoomed in to capture an image as accurately as possible.

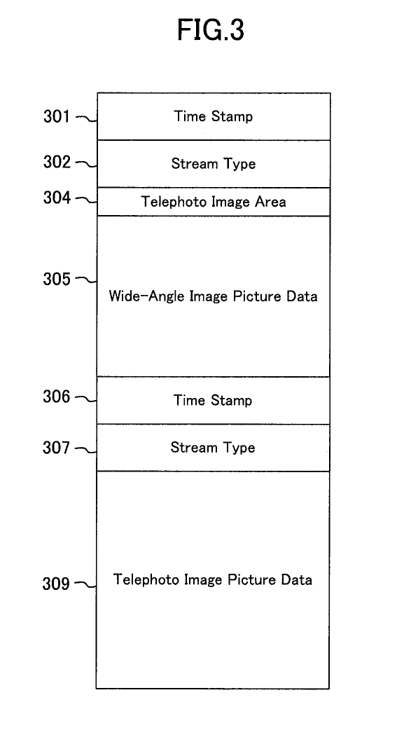

A wide-angle image and a telephoto image captured in the above-described manner are sent to the signal processor 107, and are recorded on the recording medium 108. FIG. 3 shows the overall format for recording.

When recording, two video signals for a wide-angle image and a telephoto image have to be simultaneously recorded. Therefore, the two video signals are preferably recorded in multiplex form as shown in FIG. 3.

In the record format of FIG. 3, the reference character 301 denotes a time stamp. This information is used in playback synchronization. As synchronization based on a time stamp is employed in standards such as MPEG, adding a time stamp is a conventional technique.

The reference character 302 denotes a stream type. In this example, information indicating a wide-angle image is contained.

The reference character 304 denotes a telephoto image area (or location). When information indicating a wide-angle image is contained as the stream type 302, the telephoto image area corresponding to the wide-angle image is contained as the telephoto image area 304. The area information is information indicating a part of a wide-angle image which is recorded as a telephoto image, and is used during playback. This information is unique to the present invention, and its use and advantages will be described later.

Picture data of a wide-angle image is stored in 305.

The reference character 306 denotes a time stamp.

The reference character 307 denotes a stream type, and in this example, information indicating a telephoto image is contained. In this case, there is no information corresponding to the telephoto image area 304, and picture data of telephoto image is stored in 309.

As described above, this record format is characterized in that the telephoto image area information 304 is recorded therein.

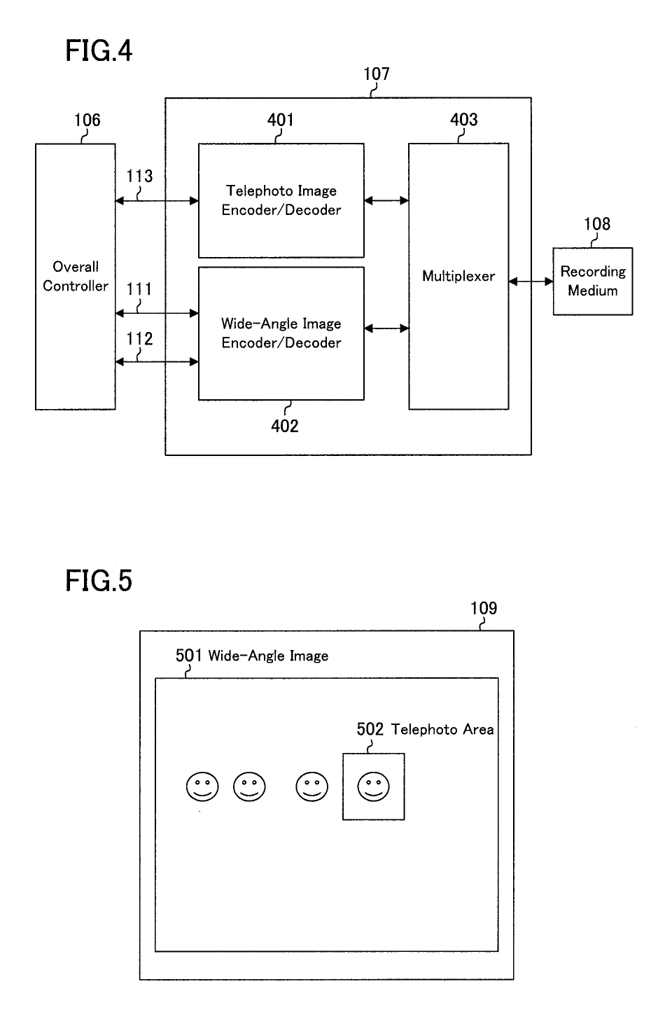

FIG. 4 shows details of the signal processor 107. The signal processor 107 handles two types (or two sequences) of images (i.e., a telephoto image and a wide-angle image), and includes two types of encoders/decoders 401 and 402.

Here, during recording, the telephoto video signal 113, the telephoto area information 111, and the wide-angle video signal 112 are sent from the overall controller 106.

The telephoto video signal 113 is encoded by the telephoto image encoder/decoder 401, and is output to a multiplexer 403.

The telephoto area information 111 and the wide-angle video signal 112 are encoded by the wide-angle image encoder/decoder 402, and are output to the multiplexer 403.

Here, as shown in FIG. 3, the telephoto area information 111 is encoded as the telephoto image area 304.

In the multiplexer 403, each signal is multiplexed in the record format shown in FIG. 3, and is output as a single stream. Then, the output is recorded on the recording medium 108.

As the recording medium 108, any recording media such as tapes, hard disks, optical disks, SD cards, etc. can be used. It will be appreciated that, since the multiple signals are multiplexed into a single stream, problems do not occur even when such an output is recorded on a medium such as a tape in which a random access cannot be easily performed.

Clearly, it is possible to record two images as separate files on a medium in which a random access can be performed. However, information indicating the association (or the link) of the two images is lost when the two images are recorded as separate files, and thus, it is more preferable to record two images as a single file.

A case where playback of an image recorded in the above-described format is performed will be described below. For convenience, the camcorder 101 is used as a playback apparatus, but such a playback apparatus and a recording apparatus do not have to be implemented as a single apparatus.

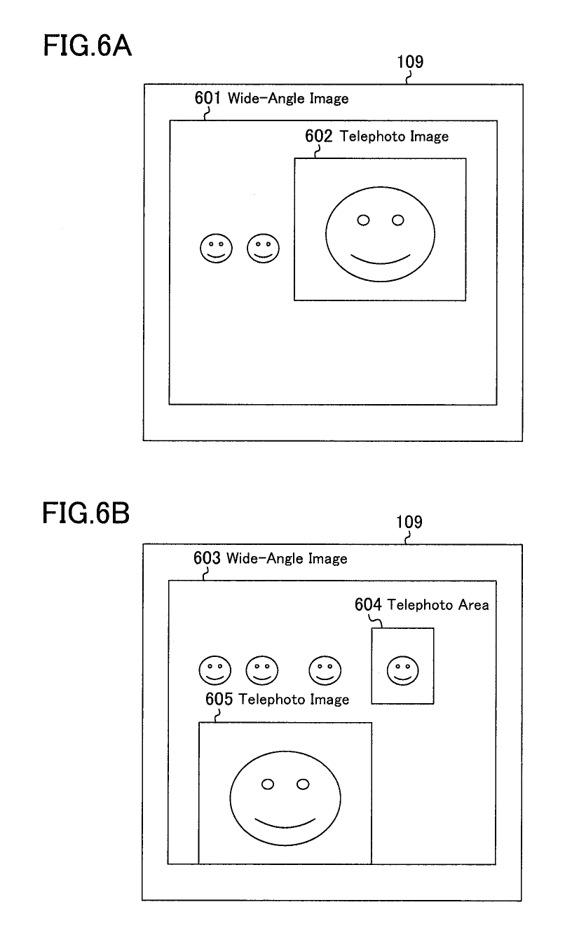

FIG. 5 and FIGS. 6A and 6B show example display images.

During playback, stream data read from the recording medium 108 is sent to the signal processor 107; and the telephoto area information 111, the wide-angle video signal 112, and the telephoto video signal 113 are decoded. Specifically, a stream is demultiplexed by the multiplexer 403 (shown in FIG. 4) of the signal processor 107, and demultiplexed streams are each decoded by a corresponding one of the decoders 401 and 402. Here, the telephoto area information 111 is also decoded. This processing is possible because the telephoto image area 304 is recorded as described above referring to FIG. 3.

The overall controller 106 displays an image on the operation monitor 109 based on the information 111, 112 and 113. As an example, a two-window display shown in FIG. 2 is possible. Here, the frame 203 can be realized by surrounding an area calculated based on the telephoto area information 111.

As another display example, as shown in FIG. 5, a wide-angle image 501 is displayed on the operation monitor 109. Here, a telephoto area 502 can be displayed on the wide-angle image 501 using the telephoto area information 111. By seeing the displayed zoom area, the user can recognize the location of the telephoto area 502 in the overall frame.

In many cases, the telephoto area 502 is an area on which the user focuses the user's attention during video shooting, that is, the telephoto area 502 indicates an area including a location of the user's child on which the user wishes to zoom in. Thus, this display example can be used when the user views an overall scene while checking the location of the user's child.

Then, it is also possible to switch the image from a wide-angle image to a telephoto image if necessary. Since the telephoto area 502 is known to the user in advance, it is possible to switch the image from a wide-angle image to a telephoto image when a region on which the user wishes to focus attention is covered by the telephoto area 502.

If a telephoto area is reliably and accurately captured during image capturing, the above function may not seem so necessary. However, telephoto shooting can sometimes fail, where the user may wish to view an overall scene rather than a telephoto image. Thus, only when it is confirmed that a telephoto image of the desired area is properly captured, the user can view such a telephoto image.

It is also an advantage that such switching described above can be performed in real-time during playback. In general, spending time for editing can achieve the above-described advantages. However, the present example provides an advantage where the user can switch the image while watching the image without time-consuming editing.

FIGS. 6A and 6B shows example overlay displays of a telephoto image 602 on a wide-angle image 601.

In this case, as shown in FIG. 6A, the telephoto image 602 can be displayed near a telephoto area of the wide-angle image 601, or as shown in FIG. 6B, a telephoto image 605 can be displayed at a different location from a telephoto area 604. Also, a playback effect where the telephoto image 605 is moved depending on the location of the telephoto area 604, etc. can be achieved. In other words, telephoto area 605 can be positioned outside of the wide-angle image 603.

As described above, since the telephoto area information 111 is utilized, the above playback effect can be easily achieved. The telephoto area information 111 is automatically recorded by a zooming operation, and thus, can be easily used without requiring post-production editing.

The example where two optical systems are provided has been described in the first embodiment.

The two optical systems 102 and 103 capture images of the objects, of which distances are approximately the same, and of which brightnesses are also approximately the same. Thus, the focus and the aperture are correlated with each other. The example embodiment may employ any suitable techniques where a same or similar process is used for the optical systems 102 and 103 by utilizing such correlation. The signal processor 107 may employ any suitable techniques similar to those mentioned above.

Clearly, image capturing using only one of the optical systems can be performed. In such a case, for example, image capturing may be performed so that, if the focal length of the optical system (or the zoom magnification) is large, the telephoto optical system 102 is used, and, if the zoom magnification is small, the wide-angle optical system 103 is used.

Here, assuming that image capturing is performed at a school athletic meet, telephoto images are primarily captured in many scenes. In such a case, different image qualities may be utilized for the wide-angle image and the telephoto image. For example, the data rate for a wide-angle image may be reduced, or the encoding performance for a wide-angle image may be reduced. When the data rate is reduced, the recording time can be advantageously increased. When the encoding performance is reduced, costs can be advantageously reduced.

### Second Embodiment

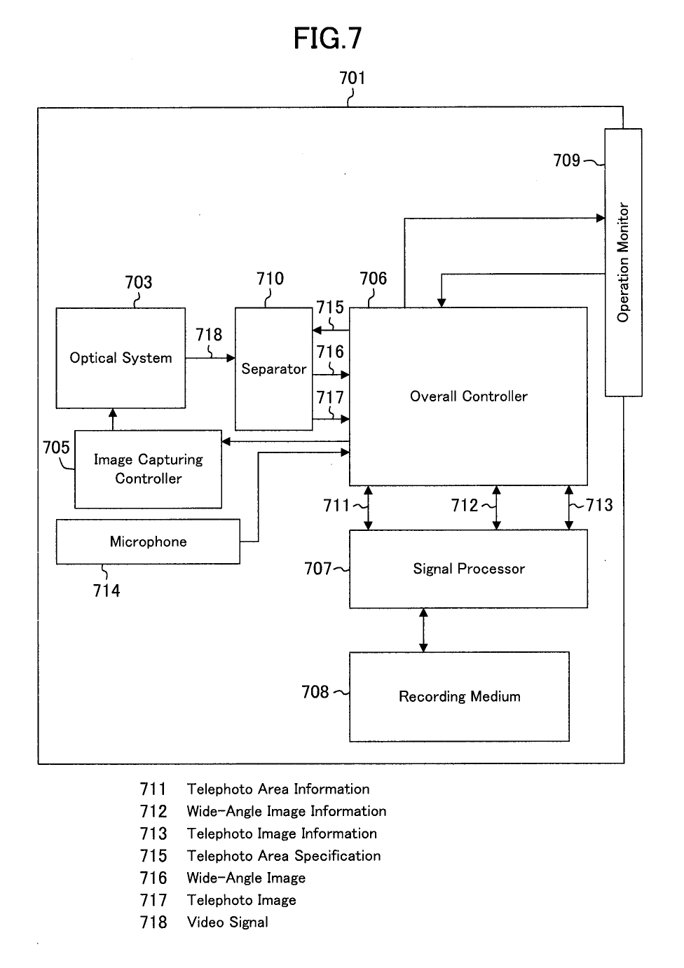

FIG. 7 shows a camcorder according to a second embodiment. A camcorder 701 of FIG. 7 includes only a single optical system. However, a separator 710 is provided instead, which is one of the features of the camcorder 701. As compared to the first embodiment, the image quality of the second embodiment may be low. However, this embodiment may be advantageous with respect to cost reduction because of its single optical system. The differences between the embodiments provide a trade-off between the costs and the picture quality. Such a trade-off varies depending on the circumstances.

An overall controller 706, a signal processor 707 and a recording medium 708 of the camcorder 701 of FIG. 7 correspond to the overall controller 106, the signal processor 107 and the recording medium 108 of the camcorder 101 of FIG. 1, respectively. Since operations of these elements shown in FIG. 7 are similar to those of FIG. 1, description of the overall controller 706, the signal processor 707, and the recording medium 708 will be omitted. An operation monitor 709 is similar to the operation monitor 109 of FIG. 1, and its operation during playback is similar to that of the first embodiment.

An optical system 703 substantially corresponds to the wide-angle optical system 103 of FIG. 1. A microphone 714 corresponds to the wide-angle microphone 114 of FIG. 1, and an image capturing controller 705 corresponds to the wide-angle image capturing controller 105 of FIG. 1.

Unlike the camcorder 101 of FIG. 1, the telephoto optical system 102 is not provided in the camcorder 701 of FIG. 7. A telephoto area specification 715 during image capturing is sent to the separator 710 instead.

The separator 710 receives a video signal 718 captured by the optical system 703, and generates a wide-angle image 716 and a telephoto image 717.

Similar to the overall controller 106 of FIG. 1, the overall controller 706 receives the wide-angle image 716 and the telephoto image 717 to display an image on the operation monitor 709. Also, the overall controller 706 sends telephoto area information 711, wide-angle video signal 712, and telephoto video signal 713 to the signal processor 707.

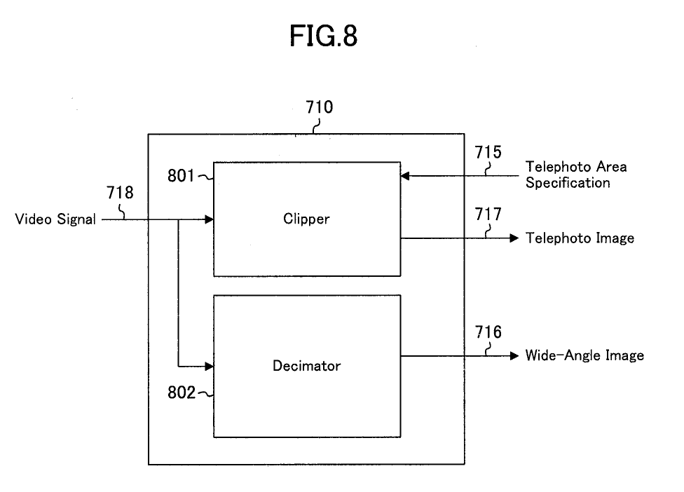

FIG. 8 is a block diagram of the separator 710.

The video signal 718 is sent to each of a clipper 801 and a decimator 802. The clipper 801 clips (or cut out) a region specified by the telephoto area specification 715 from the video signal 718, and outputs the clipped region as a telephoto image 717. The decimator 802 decimates the video signal 718 to reduce a data amount, and outputs the decimated video signal 718 as the wide-angle image 716. Here, the data amount is reduced by the decimator 802 because it is assumed that a CCD at high resolution, etc. is used.

As in the camcorder 701 of FIG. 7, when only a single optical system is provided, zooming is achieved by digital zoom processing, and thus, the image quality tends to be deteriorated. Therefore, an image needs to be recorded at a higher resolution than that of a regular camcorder. Such high-resolution recording involves an excessively large amount of data. As such, it is more preferable that the decimator 802 reduces the data amount.

Regarding playback, a mechanism similar to that of FIG. 1 is used, and thus, the description thereof will be omitted.

Video image (or motion picture) capturing has been described in the first and second embodiments using a camcorder as an example. However, the same or similar mechanism can be used in still image capturing. In such still picture image capturing, images are often recorded at a higher resolution than that of video image capturing. Thus, the embodiment of FIG. 7 employing a high-resolution charge-coupled device (CCD), etc. is perfectly feasible.

In addition, with the recent advances of the semiconductor technologies, it has become easier to implement each functional block as a single chip LSI. Specifically, the cost for two-channel recording has been reduced, and thus, it is feasible to implement such devices as commercial products.

As described above, use of the camcorders according to the present embodiments allows both of an image of an overall performance and an image of a performance of an individual to be easily recorded by a single camera at a school athletic meet, etc., and also allows better playback effects during playback.

Image capturing apparatuses according to the present invention have a function which allows simultaneous recording of an overall image, and an enlarged partial image of the overall image, and thus, can be advantageously utilized in image capturing at a school athletic meet, etc.

What is claimed is:

1. An image capturing apparatus, comprising:
an imaging capturing device configured to capture an image;
a telephoto area selector configured to select a portion of the image being captured by the image capturing device;
an image encoder configured to encode the image being captured by the image capturing device; and
a recorder configured to record the portion of the image selected by the telephoto area selector, and the image encoded by the image encoder in association with each other.

2. The image capturing apparatus of claim 1, further comprising:
a monitor configured to display the image being captured by the image capturing device in real-time,
wherein
the portion of the image selected by the telephoto area selector is displayed on the monitor.

3. The image capturing apparatus of claim 2, wherein
the portion of the image selected by the telephoto area selector is enlarged, and the enlarged image is displayed on the monitor.

4. The image capturing apparatus of claim 2, wherein
the telephoto area selector selects, as the portion of the image, a predetermined area around a location specified by a user within the image displayed on the monitor.

5. The image capturing apparatus of claim 1, further comprising:
a telephoto image encoder configured to encode an enlarged image of the portion of the image selected by the telephoto area selector,
wherein
the recorder records the enlarged image encoded by the telephoto image encoder, and the image encoded by the image encoder in association with each other.

6. The image capturing apparatus of claim 5, further comprising:
a multiplexer configured to multiplex the enlarged image encoded by the telephoto image encoder, and the image encoded by the image encoder into a single stream,
wherein
the recorder records the single stream on a recording medium.

7. The image capturing apparatus of claim 1, wherein
the image capturing device includes an optical system configured to capture a telephoto image in the portion of the image selected by the telephoto area selector.

8. The image capturing apparatus of claim 1, further comprising:
a decimator configured to decimate the image being captured by the image capturing device to reduce a resolution of the image; and
a clipper configured to clip the portion of the image selected by the telephoto area selector from the image being captured by the image capturing device,
wherein
the recorder records the image decimated by the decimator, and the image clipped by the clipper.

9. An image encoding apparatus, comprising:
a first encoder configured to receive a first video signal, area information indicating an area of the first video signal on a screen, and a second video signal, and to encode the first video signal with the area information;
a second encoder configured to encode the second video signal; and
a multiplexer configured to multiplex a first version encoded by the first encoder, and a second version encoded by the second encoder.

10. An image encoding apparatus, comprising:
a decimator configured to decimate a first video signal to reduce a resolution;
a clipper configured to clip a video signal in a selected area from the first video signal;
a first encoder configured to encode the video signal decimated by the decimator, and information indicating the selected area;
a second encoder configured to encode the video signal clipped by the clipper; and
a multiplexer configured to multiplex a first version encoded by the first encoder, and a second version encoded by the second encoder.
